(19) United States
(12) Patent Application Publication
(10) Pub. No.: US 2017/0161006 A1
(43) Pub. Date: Jun. 8, 2017

(54) MOBILE TERMINAL AND METHOD FOR CONTROLLING THE SAME

(71) Applicant: LG ELECTRONICS INC., Seoul (KR)

(72) Inventors: Eun KWON, Seoul (KR); Soyoung BAE, Seoul (KR)

(73) Assignee: LG Electronics Inc., Seoul (KR)

(21) Appl. No.: 15/115,850

(22) PCT Filed: Nov. 7, 2014
(86) PCT No.: PCT/KR2014/010668

§ 371 Date: Aug. 1, 2016

(30) Foreign Application Priority Data
Mar. 3, 2014 (KR) 10-2014-0024989

(51) Int. Cl. G06F 3/14; G06F 3/01; G06F 3/147

(52) U.S. Cl. CPC G06F 3/1423; G06F 3/147; G06F 3/017

(57) ABSTRACT

A mobile terminal and a method for controlling the same are disclosed. The mobile terminal includes: a case having a plurality of faces; a sensing unit provided inside the case; a display unit seamlessly provided to at least two of the plurality of faces; and a controller configured to display a first display unit and a second display unit of the display unit such that the first display unit and the second display unit respectively correspond to a first face and a second face of an entity and to change an image displayed on at least one of the first and second display units to correspond to a position change of the case upon sensing of the position change of the case through the sensing unit, the first and second display units having different directions.

### TECHNICAL FIELD

The present invention relates to a mobile terminal, which changes display of a display unit on which an image of an entity is displayed in response to a user operation applied to a case so as to arouse user's interest and provide convenient use environment, and a method for controlling the same.

### BACKGROUND ART

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

Efforts are ongoing to support and increase the functionality of mobile terminals. Such efforts include software and hardware improvements, as well as changes and improvements in the structural components.

### DISCLOSURE OF INVENTION

### Technical Problem

An object of the present invention to solve the aforementioned problems and other problems. Another object of the present invention is to provide a mobile terminal, which changes display of a display unit on which an image of an entity is displayed in response to a user operation applied to a case so as to arouse user's interest and provide convenient use environment, and a method for controlling the same.

### Solution to Problem

In an aspect of the present invention to accomplish the aforementioned or other objects, a mobile terminal includes: a case having a plurality of faces; a sensing unit provided inside the case; a display unit seamlessly provided to at least two of the plurality of faces; and a controller configured to display a first display unit and a second display unit of the display unit such that the first display unit and the second display unit respectively correspond to a first face and a second face of an entity and to change an image displayed on at least one of the first and second display units to correspond to a position change of the case upon sensing of the position change of the case through the sensing unit, the first and second display units having different directions.

In another aspect of the present invention, provided herein is a method for controlling a mobile terminal, including: providing a first display unit and a second display unit having different directions such that the first display unit and the second display unit respectively correspond to a first face and a second face of an entity; sensing position change of a case; and changing an image displayed on at least one of the first and second display units to correspond to the position change of the case.

### Advantageous Effects of Invention

The mobile terminal and method for controlling the same according to the present invention have the following advantages.

According to at least one embodiment of the present invention, it is possible to change display of a display unit on which an image of an entity is displayed in response to a user operation applied to a case so as to arouse user's interest and provide convenient use environment.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF DRAWINGS

FIG. 1A is a block diagram of a mobile terminal in accordance with the present disclosure.

FIGS. 1B and 1C are conceptual views of one example of the mobile terminal, viewed from different directions.

FIG. 2 is a conceptual view of a deformable mobile terminal according to an alternative embodiment of the present disclosure.

FIG. 3 illustrates a mobile terminal according to another embodiment of the present disclosure.

FIG. 4 illustrates a mobile terminal according to another embodiment of the present disclosure.

FIG. 5 illustrates a backside of a mobile terminal according to an embodiment of the present invention.

FIG. 6 is a flowchart illustrating an operation of the mobile terminal according to an embodiment of the present invention.

FIGS. 7 and 8 illustrate display states of the mobile terminal shown in FIG. 6.

FIGS. 9 to 15 illustrate operations of the mobile terminal shown in FIG. 6.

FIGS. 16 to 18 illustrate operations of the mobile terminal shown in FIG. 6 according to another embodiment of the present invention.

FIGS. 19 to 21 illustrate operations of the mobile terminal shown in FIG. 6 according to another embodiment of the present invention.

FIGS. 22 to 24 illustrate operations of the mobile terminal shown in FIG. 6 according to another embodiment of the present invention.

FIGS. 25 to 29 illustrate operations of the mobile terminal shown in FIG. 6 according to another embodiment of the present invention.

### MODE FOR THE INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be connected with the other element or intervening elements may also be present. In contrast, when an element is referred to as being “directly connected with” another element, there are no intervening elements present.

A singular representation may include a plural representation unless it represents a definitely different meaning from the context. Terms such as “include” or “has” are used herein and should be understood that they are intended to indicate an existence of several components, functions or steps, disclosed in the specification, and it is also understood that greater or fewer components, functions, or steps may likewise be utilized.

Mobile terminals presented herein may be implemented using a variety of different types of terminals. Examples of such terminals include cellular phones, smart phones, user equipment, laptop computers, digital broadcast terminals, personal digital assistants (PDAs), portable multimedia players (PMPs), navigators, portable computers (PCs), slate PCs, tablet PCs, ultra books, wearable devices (for example, smart watches, smart glasses, head mounted displays (HMDs)), and the like.

By way of non-limiting example only, further description will be made with reference to particular types of mobile terminals. However, such teachings apply equally to other types of terminals, such as those types noted above. In addition, these teachings may also be applied to stationary terminals such as digital TV, desktop computers, and the like.

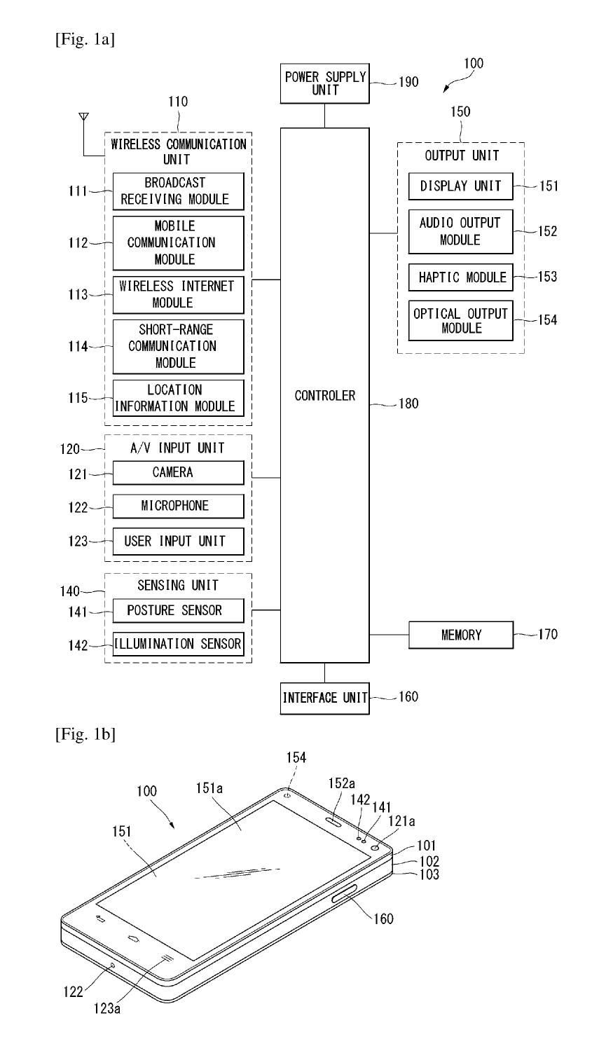

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions.

The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

Referring now to FIG. 1A, the mobile terminal 100 is shown having wireless communication unit 110 configured with several commonly implemented components. For instance, the wireless communication unit 110 typically includes one or more components which permit wireless communication between the mobile terminal 100 and a wireless communication system or network within which the mobile terminal is located.

The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154.

The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 may provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO(Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies.

Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which is able to exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. On the other hand, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this case, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others.

As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 may sense which region of the display unit 151 has been touched. Here, the touch controller may be a component separate from the controller 180, the controller 180, and combinations thereof.

In some embodiments, the controller 180 may execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor.

Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented in such a manner that the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 may typically control the general operations of the mobile terminal 100. For example, the controller 180 may set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected.

As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance.

Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like.

As an alternative to the example in which the plurality of cases form an inner space for accommodating components, the mobile terminal 100 may be configured such that one case forms the inner space. In this example, a mobile terminal 100 having a uni-body is formed in such a manner that synthetic resin or metal extends from a side surface to a rear surface.

If desired, the mobile terminal 100 may include a waterproofing unit (not shown) for preventing introduction of water into the terminal body. For example, the water-proofing unit may include a waterproofing member which is located between the window 151a and the front case 101, between the front case 101 and the rear case 102, or between the rear case 102 and the rear cover 103, to hermetically seal an inner space when those cases are coupled.

FIGS. 1B and 1C depict certain components as arranged on the mobile terminal. However, it is to be understood that alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a.

The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this case, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170.

The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof.

Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit (not shown) may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen.

As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds.

The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject.

As shown in FIG. 1B, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

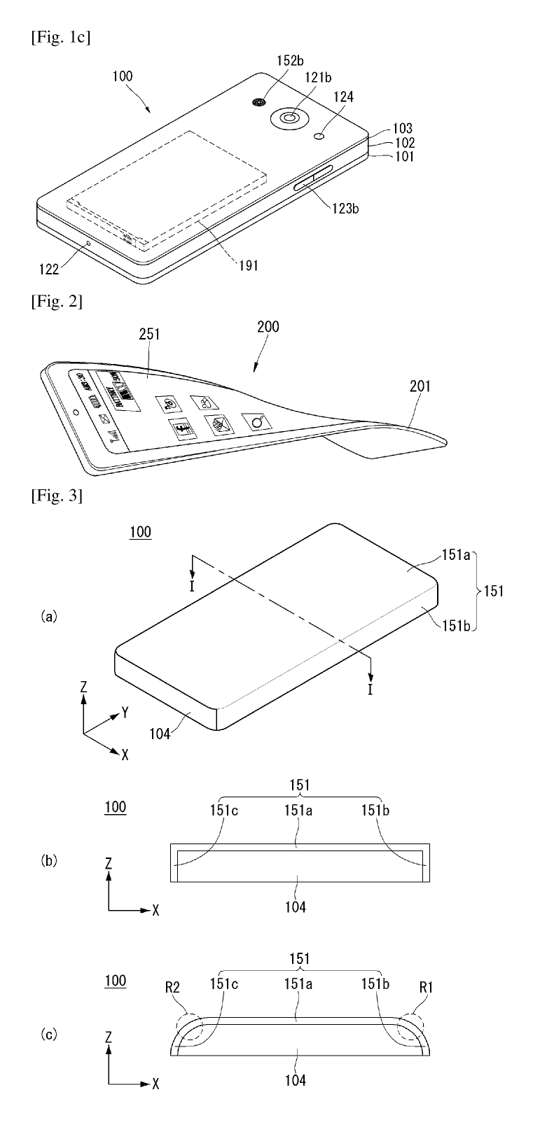

FIG. 2 is a conceptual view of a deformable mobile terminal according to an alternative embodiment of the present invention. In this figure, mobile terminal 200 is shown having display unit 251, which is a type of display that is deformable by an external force. This deformation, which includes display unit 251 and other components of mobile terminal 200, may include any of curving, bending, folding, twisting, rolling, and combinations thereof. The deformable display unit 251 may also be referred to as a “flexible display unit.” In some implementations, the flexible display unit 251 may include a general flexible display, electronic paper (also known as e-paper), and combinations thereof. In general, mobile terminal 200 may be configured to include features that are the same or similar to that of mobile terminal 100 of FIGS. 1A-1C.

The flexible display of mobile terminal 200 is generally formed as a lightweight, non-fragile display, which still exhibits characteristics of a conventional flat panel display, but is instead fabricated on a flexible substrate which can be deformed as noted previously.

The term e-paper may be used to refer to a display technology employing the characteristic of a general ink, and is different from the conventional flat panel display in view of using reflected light. E-paper is generally understood as changing displayed information using a twist ball or via electrophoresis using a capsule.

When in a state that the flexible display unit 251 is not deformed (for example, in a state with an infinite radius of curvature and referred to as a first state), a display region of the flexible display unit 251 includes a generally flat surface. When in a state that the flexible display unit 251 is deformed from the first state by an external force (for example, a state with a finite radius of curvature and referred to as a second state), the display region may become a curved surface or a bent surface. As illustrated, information displayed in the second state may be visual information output on the curved surface. The visual information may be realized in such a manner that a light emission of each unit pixel (sub-pixel) arranged in a matrix configuration is controlled independently. The unit pixel denotes an elementary unit for representing one color.

According to one alternative embodiment, the first state of the flexible display unit 251 may be a curved state (for example, a state of being curved from up to down or from right to left), instead of being in flat state. In this embodiment, when an external force is applied to the flexible display unit 251, the flexible display unit 251 may transition to the second state such that the flexible display unit is deformed into the flat state (or a less curved state) or into a more curved state.

If desired, the flexible display unit 251 may implement a flexible touch screen using a touch sensor in combination with the display. When a touch is received at the flexible touch screen, the controller 180 can execute certain control corresponding to the touch input. In general, the flexible touch screen is configured to sense touch and other input while in both the first and second states.

One option is to configure the mobile terminal 200 to include a deformation sensor which senses the deforming of the flexible display unit 251. The deformation sensor may be included in the sensing unit 140.

The deformation sensor may be located in the flexible display unit 251 or the case 201 to sense information related to the deforming of the flexible display unit 251. Examples of such information related to the deforming of the flexible display unit 251 may be a deformed direction, a deformed degree, a deformed position, a deformed amount of time, an acceleration that the deformed flexible display unit 251 is restored, and the like. Other possibilities include most any type of information which can be sensed in response to the curving of the flexible display unit or sensed while the flexible display unit 251 is transitioning into, or existing in, the first and second states.

In some embodiments, controller 180 or other component can change information displayed on the flexible display unit 251, or generate a control signal for controlling a function of the mobile terminal 200, based on the information related to the deforming of the flexible display unit 251. Such information is typically sensed by the deformation sensor.

The mobile terminal 200 is shown having a case 201 for accommodating the flexible display unit 251. The case 201 can be deformable together with the flexible display unit 251, taking into account the characteristics of the flexible display unit 251.

A battery (not shown in this figure) located in the mobile terminal 200 may also be deformable in cooperation with the flexible display unit 261, taking into account the characteristic of the flexible display unit 251. One technique to implement such a battery is to use a stack and folding method of stacking battery cells.

The deformation of the flexible display unit 251 not limited to perform by an external force. For example, the flexible display unit 251 can be deformed into the second state from the first state by a user command, application command, or the like.

FIG. 3 illustrates a mobile terminal according to another embodiment of the present invention.

As shown in FIG. 3, the mobile terminal 100 according to another embodiment of the present invention may include a display unit 151 which is seamlessly provided to at least two of a plurality of faces of a case 104.

Referring to FIG. 3(a), the case 104 of the mobile terminal 100 may have a hexahedral shape. For example, the case 104 can be formed in a hexahedral shape having wider front and rear faces on the X-Y plane and narrower faces connecting the front and rear faces.

The display unit 151 may be provided to a plurality of faces of the case 104. For example, the display unit 151 can include a first display unit 151a provided to the front face of the case 104 and a second display unit 151b provided to both sides of the first display unit 151a.

The display unit 151 may be seamlessly formed over the plurality of faces of the case 104. While the figure shows that the display unit 151 is segmented into first, second and third display units 151a, 151b and 151c for convenience of description, the first, second and third display units 151a, 151b and 151c correspond to one seamless display unit.

Since the display unit 151 is seamlessly formed over the plurality of faces of the case 104, an image displayed on the display unit 151 may be changed. That is, information can be displayed in various manners since the display unit is extended to the sides of the mobile terminal 100, distinguished from the conventional display unit provided only to the front face of the mobile terminal. For example, display can reflect characteristics of an entity, which will be described below in detail.

FIG. 3(b) is a cross-sectional view of the mobile terminal 100, taken along line I-I of FIG. 3(a). As shown in FIG. 3(b), the display unit 151 of the mobile terminal 100 may be provided to at least three faces of the mobile terminal 100. That is, the display unit 151 may include the first display unit 151a provided to the front face of the mobile terminal 100, and the second and third display units 151b and 151c respectively provided to sides of the mobile terminal 100.

Referring to FIG. 3(c), first and/or second round portions R1 and R2 may be provided to the boundary of the first display unit 151a and the second display unit 151b and/or the boundary of the first display unit 151a and the third display unit 151c.

The display unit 151 may be a flexible display which can be bent to a predetermined degree. Accordingly, the boundary of the first display unit 151 and the second and/or third display units 151b and 151c may be bent having a specific rotational radius according to the flexibility of the display unit.

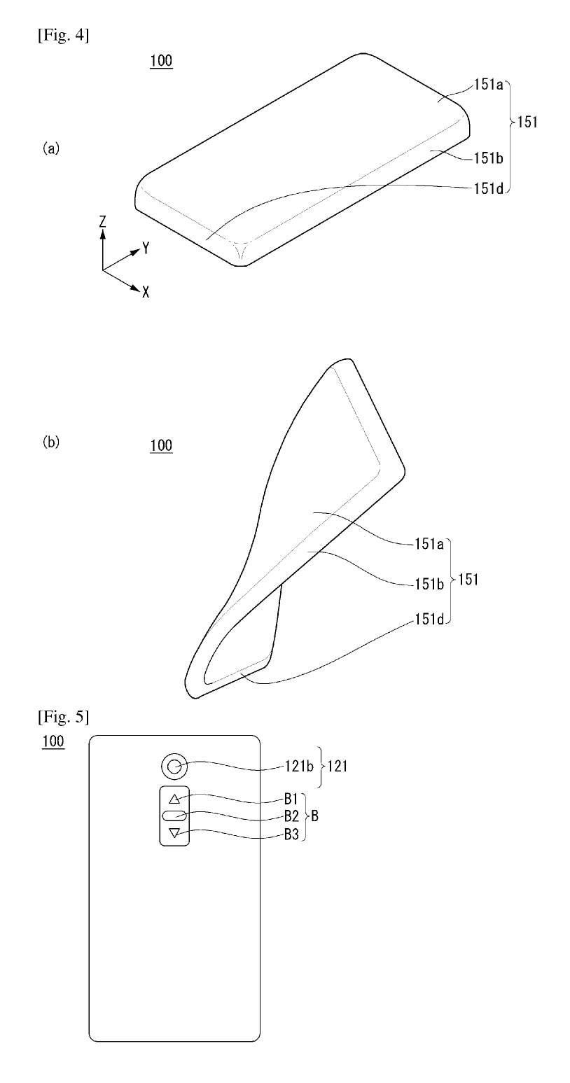

FIG. 4 illustrates a mobile terminal according to another embodiment of the present invention.

Referring to FIG. 4(a), the mobile terminal 100 according to the present embodiment may include a display unit 1 151 provided to four or more faces of the mobile terminal 100. For example, the display unit may include a fourth display unit 151d extended to the bottom face of the mobile terminal 100. Furthermore, the display unit may further include a fifth display unit extended to the top face of the mobile terminal 100 and/or a sixth display unit extended to the bottom face thereof. The fourth, fifth and sixth display units may correspond to one seamless display unit, as described above.

Referring to FIG. 4(b), the mobile terminal 100 may be flexible. The display unit 151 may also be flexible in response to bending of the case of the mobile terminal 100.

FIG. 5 illustrates a rear face of a mobile terminal according to one embodiment of the present invention.

As shown in FIG. 5, buttons B through which user operations can be applied may be provided to the rear face of the mobile terminal 100 according to one embodiment of the present invention.

The buttons B may be located at the center of the rear side of the mobile terminal 100. Accordingly, the user who grips the mobile terminal 100 with a hand can manipulate the buttons B using a finger of the hand while gripping the mobile terminal 100. The mobile terminal 100 according to one embodiment of the present invention may include the display unit 151 extended to sides of the mobile terminal 100, as described above. Accordingly, a volume button and the like, which are provided to a side of the conventional mobile terminal, may be moved to other positions. The buttons B of the mobile terminal 100 according to one embodiment may be provided to the rear face thereof. Accordingly, the user can apply desired operations through the rear buttons B even though the display unit 151 is extended.

A plurality of buttons B may be provided. For example, the buttons B can include first, second and third buttons B1, B2 and B3 respectively corresponding to different functions.

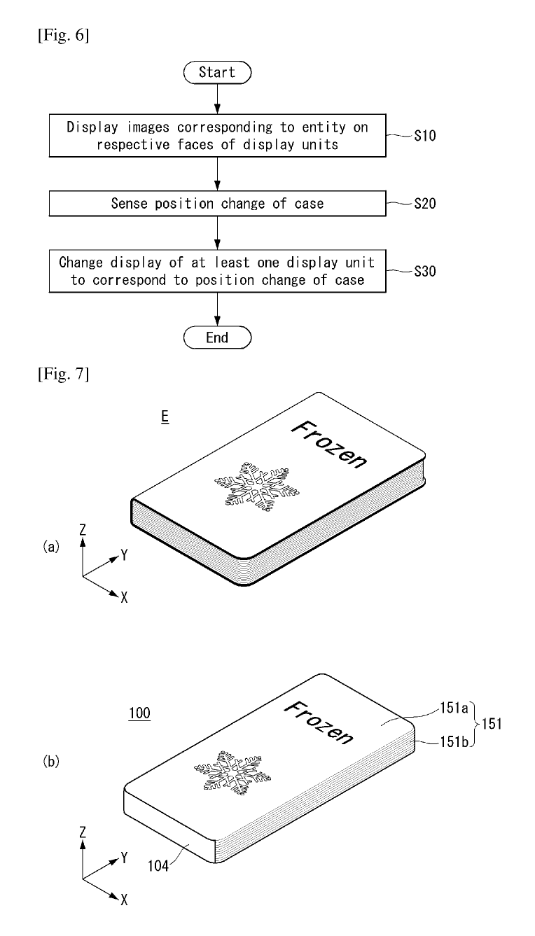

FIG. 6 is a flowchart illustrating an operation of the mobile terminal according to one embodiment of the present invention.

Referring to FIG. 6, the controller 180 of the mobile terminal 100 according to one embodiment of the present invention may display images on respective faces of the display unit 151 such that the images correspond to an entity in step S10.

The entity may refer to a real object. For example, the entity can include material objects such as a book, tree, computer, etc. The entity may include objects of various types. However, a book is exemplified for convenience of understanding.

The controller 180 may display the images corresponding to the entity on the respective faces of the display unit 151. As described above, the mobile terminal 100 according to one embodiment of the present invention may include the display unit 151 provided to at least two faces thereof. Accordingly, the display unit 151 may display images which represent the entity in a form similar to the real form thereof, distinguished from the conventional display unit provided to only one face of the mobile terminal. For example, the first display unit 151a can display an image corresponding to the front of the entity, the second display unit 151b can display an image corresponding to one side of the entity and the third display unit 151c can display an image corresponding to the other side of the entity. The entity can be represented realistically since the images of respective faces of the entity are displayed on the respective faces of the display unit 151.

The controller 180 may sense position change of the case 104 in step S20.

Position change of the case 104 may refer to position change of the mobile terminal 100. For example, the position change refers to tilting of the mobile terminal 100 gripped by the user to the left or right.

The position change of the case 104 may be sensed through a sensor included in the mobile terminal 100. For example, the position change of the mobile terminal 100 can be sensed through a sensor including an acceleration sensor and/or a position sensor.

The position change of the case 104 may be sensed through the camera 121. For example, the position change of the mobile terminal 100 can be sensed through analysis of an image captured by the camera 121.

The controller 180 may change at least one display of the display unit 151 such that the at least one display corresponds to the changed position of the case 104 in step S30.

Change of display of the display unit 151 may correspond to a user operation of changing the position of the mobile terminal 100. For example, when the user tilts the mobile terminal 100 in a specific direction, the controller 180 can change a display of the display unit 151, which corresponds to a specific face thereof, such that the display represents an image changed according to tilting of the mobile terminal 100.

An operation of the user to change the position of the mobile terminal 100 may be related to user experience with respect to the entity. A case in which the user holds a book is exemplified. The user who sees the cover of the book can turn the book such that the side of the book can be seen when attempting to turn the pages of the book. When the side of the book is seen, the user can find a desired page with one hand while turning the pages of the book with the other hand.

When the front and side of the book corresponding to an entity are respectively displayed on faces of the display unit 151, the controller 180 may change display of the second display unit 151 corresponding to a side of the mobile terminal 100 upon turning of the second display unit 151 to the user. For example, a first state in which the side of the book is displayed can be changed to a second state in which the starting position of a chapter of the book is displayed. Since display of the second display unit 151 corresponding to a side of the mobile terminal 100 is changed depending on experience of the user who used the entity, the user can use the mobile terminal 100 more intuitively.

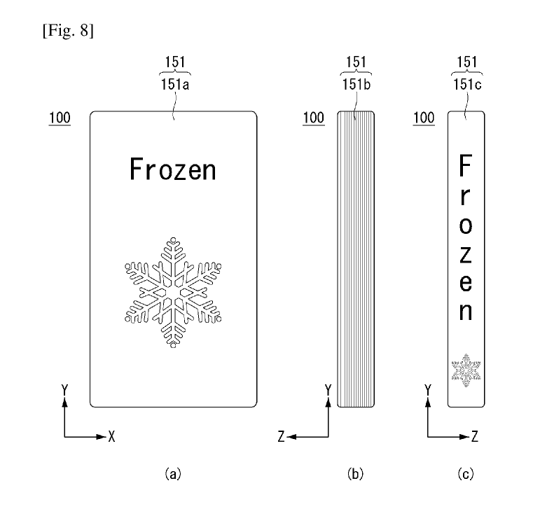

FIGS. 7 and 8 illustrate display states of the mobile terminal shown in FIG. 6.

As shown in FIGS. 7 and 8, the mobile terminal 100 according to one embodiment of the present invention may display images corresponding to an entity E on respective faces of the display unit 151.

Referring to FIG. 7(a), the entity E may be a book.

Referring to FIG. 7(b), the controller 180 may display an image of the book corresponding to the entity E on the display unit 151. The controller 180 may display an image of the cover of the book on the first display unit 151a and display an image of an unopened side of the book on the second display unit 151b.

FIG. 8 illustrates images displayed on the display unit 151. Referring to FIG. 8(a), the cover of the book can be displayed on the first display unit 151a. Referring to FIG. 8(b), a side of the book can be displayed on the second display unit 151b. Referring to FIG. 8(c), the back of the book can be displayed on the third display unit 151c.

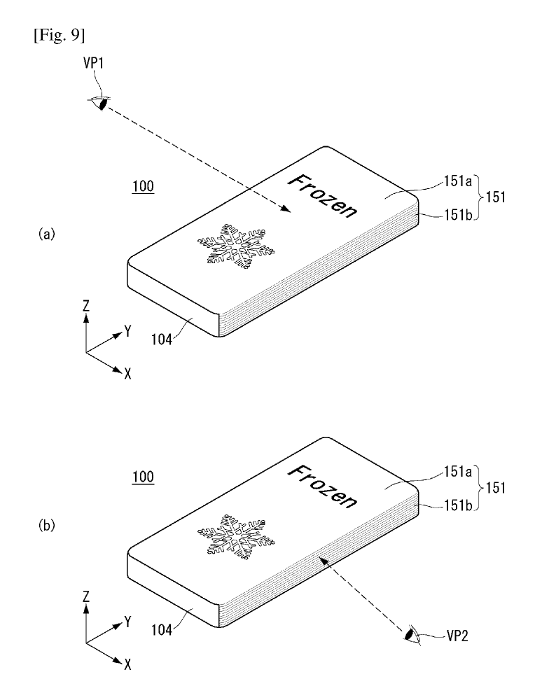

FIGS. 9 to 15 illustrate the operation of the mobile terminal shown in FIG. 6.

As shown in FIGS. 9 to 15, the mobile terminal 100 according to one embodiment of the present invention may change display of the display unit 151 in response to position change of the case 104.

Referring to FIG. 9(a), the user may see the mobile terminal at a first view point VP1. For example, the user can see the first display unit 151a of the display unit 151. The user may see the cover of the book, displayed on the first display unit 151a, at the first view point VP1.

Referring to FIG. 9(b), the user may see the mobile terminal 100 at a second view point VP2. When the user moves from the first view point VP1 to the second view point VP2, the position of the mobile terminal 100 may be fixed. For example, the user can turn the head to the second view point VP2 with the mobile terminal 100 placed on a desk. At the second view point VP2, the user my see the side of the book, which is displayed on the second display unit 151b. The side of the book, displayed on the second display unit 151b, may be in the same state irrespective of change of the user view point. That is, the second display unit 151b may display the side of the book when the user is at the first view point VP1 and when the user moves to the second view point VP2.

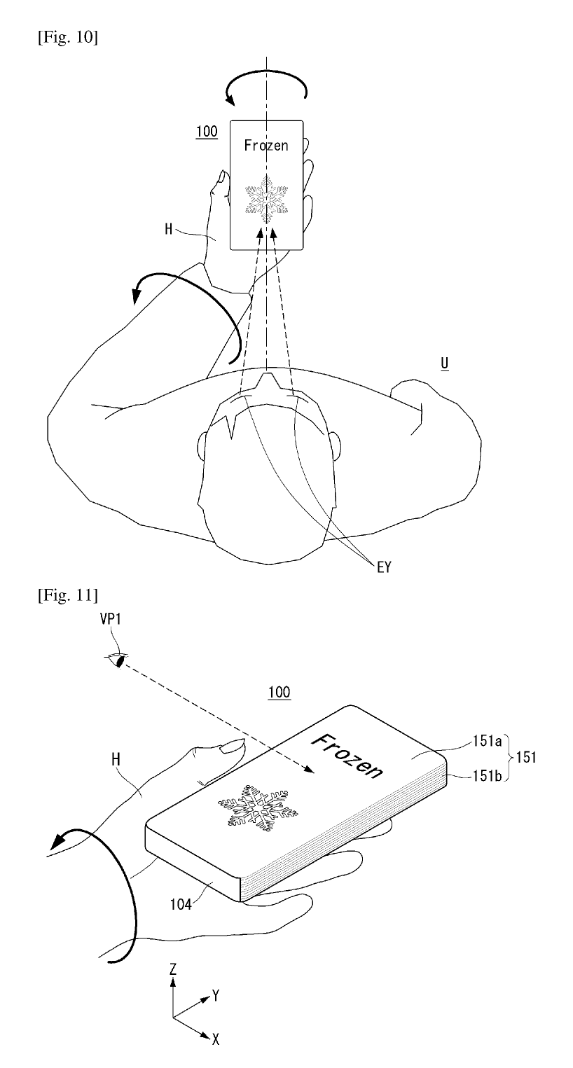

Referring to FIGS. 10 and 11, the user may grip the mobile terminal 100 using a hand H. The view point of the user when the user grips the mobile terminal 100 may be the first view point VP1. Even when the view point of the user is fixed to the first view point VP1, the user can move the hand H. When the hand H gripping the mobile terminal 100 moves, the mobile terminal is also moved and the movement of the mobile terminal 100 may be sensed by the sensing unit 140.

Upon sensing movement of the mobile terminal 100 through the sensing unit 140, the controller 180 may change display of the display unit 151 such that the display corresponds to the intention of the user to move the mobile terminal 100. For example, when the user turns the hand H holding the mobile terminal 100 to see the side of the mobile terminal 100, it can be considered that the user intends to turn the pages of the e-book displayed on the display unit 151. Accordingly, the controller 180 can change display of at least one display unit 151 corresponding thereto.

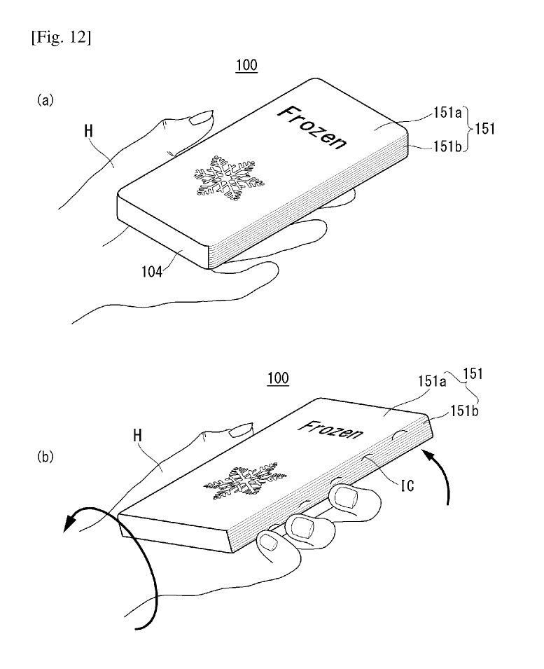

Referring to FIG. 12(a), the user may hold the mobile terminal 100. The first display unit 151a may display the cover of the e-book.

Referring to FIG. 12(b), the user may turn the hand holding the mobile terminal 100. Upon sensing of turning of the mobile terminal 100 through the sensing unit 140, the controller 180 may change display of the second display unit 151b. That is, necessary information can be displayed such that the display corresponds to the user's intention. For example, the first state in which the side of the e-book is displayed can be changed to a state in which thumbnails IC indicating chapters of the e-book are displayed.

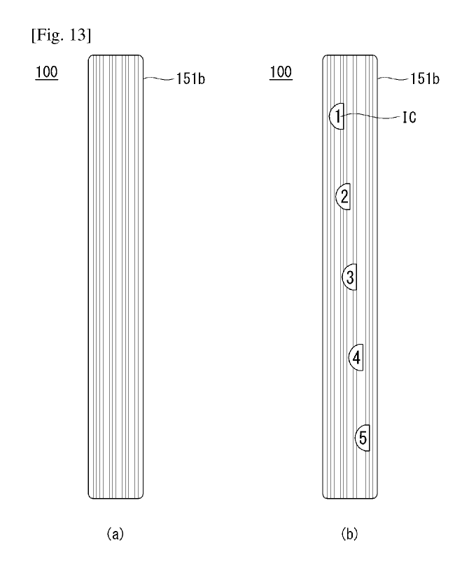

Referring to FIG. 13(a), the second display unit 151b may display the side of the e-book when the user does not change the position of the mobile terminal 100.

Referring to FIG. 13(b), when the user turns the second display unit 151b toward the user, the controller 180 may display the thumbnails IC. The thumbnails IC may be indexes of the e-book. For example, the thumbnail IC can correspond to chapter indexes, specific points designated by the user, or the like.

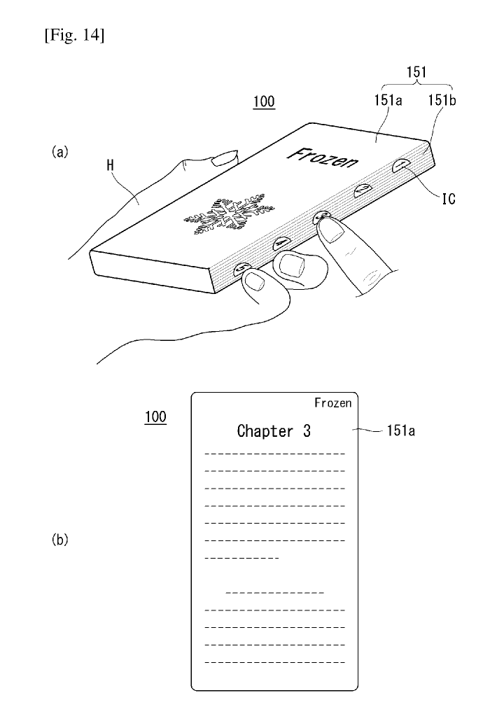

Referring to FIG. 14(a), the second display unit 151b may display at least one thumbnail IC corresponding to indexes. The user may select a specific thumbnail IC with a finger F.

Referring to FIG. 14(b), the controller 180 may change display of the first display unit 151a in response to the selection of the user, made through the second display unit 151b. For example, upon selection of the specific thumbnail IC displayed on the second display unit 151b, the controller 180 can display a page corresponding to the selected thumbnail IC on the first display unit 151a.

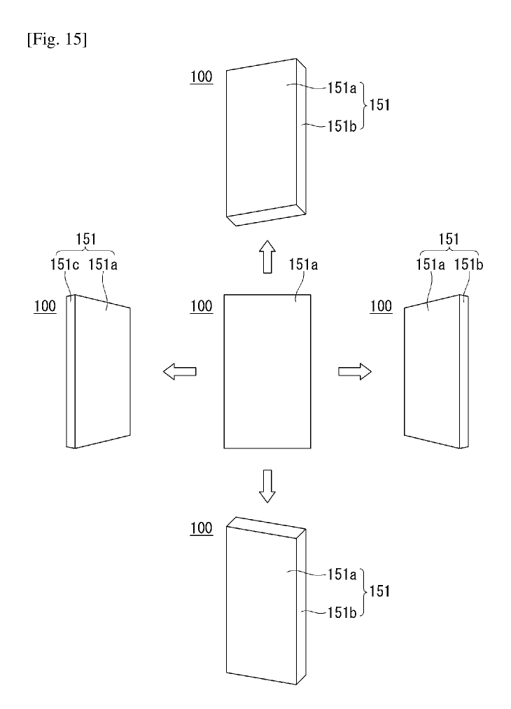

Referring to FIG. 15, the mobile terminal 100 may be tilted in various manners according to user manipulation. For example, the mobile terminal 100 can be tilted such that the second display unit 151b can be seen or the third display unit 151c, which is opposite to the second display unit 151b, can be seen. Otherwise, the mobile terminal 100 may be tilted such that the top or bottom side thereof can be seen. Tilting of the mobile terminal 100 and/or a tilting degree may be sensed by the sensing unit 140. Upon sensing of tilting, the controller 180 may change display of the first, second and third display units 151a, 151b and 151c in response thereto.

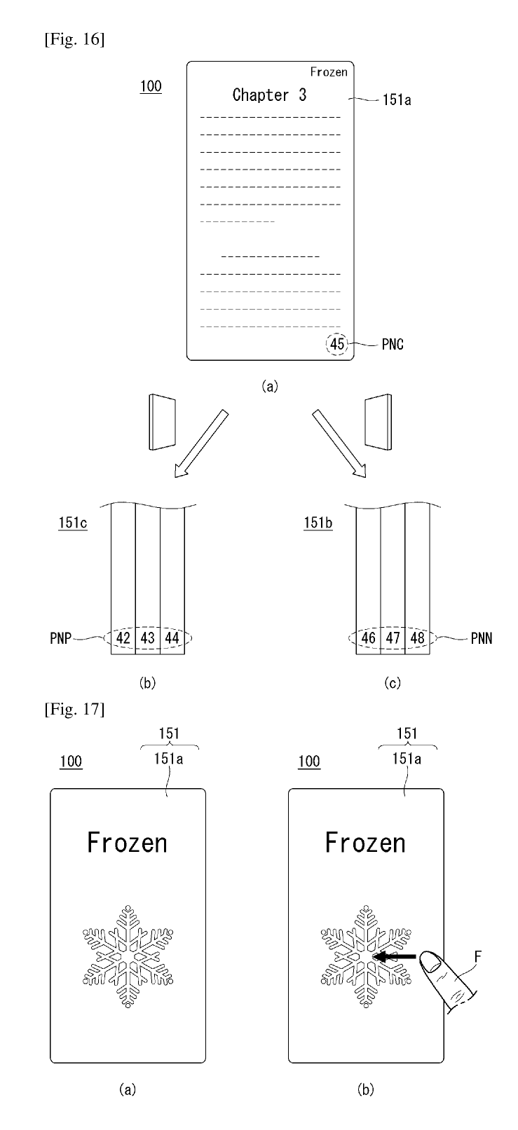

FIGS. 16 to 18 illustrate operations of the mobile terminal shown in FIG. 6 according to another embodiment of the present invention.

As shown in FIGS. 16 to 18, the controller 180 of the mobile terminal 100 according to the present embodiment may change display in various manners in response to user manipulation applied to the mobile terminal 100.

Referring to FIG. 16(a), the first display unit 151a may display a specific state of an entity. For example, a specific page of a book corresponding to the entity can be displayed on the first display unit 151a.

Referring to FIG. 16(b) and (c), the user may tilt the mobile terminal 100 to the left or right. Upon sensing of tilting of the mobile terminal 100, the controller 180 may change display of the display unit 151 in response to the tilting. The first display unit 151a may display a specific page number PNC. For example, the contents of page 45 of the e-book can be displayed on the first display unit 151.

When the user tilts the mobile terminal 100 in one direction such that the third display unit 151c is seen, the controller 180 may display previous page numbers PNP on the third display unit 151c. When the user tilts the mobile terminal 100 in the opposite direction such that the second display unit 151b is seen, the controller 180 may display next page numbers PNN on the second display unit 151b. That is, different information can be displayed depend on tilting direction. Upon selection of a specific number from numbers displayed according to tilting of the mobile terminal 100, the controller 180 may display a page corresponding to the selected number on the first display unit 151a.

Referring to FIG. 17(a), the first display unit 151a may display a specific image corresponding to the entity on the first display unit 151a. For example, the cover of the book can be displayed on the first display unit 151a.

Referring to FIG. 17(b), the user may touch the first display unit 151a. For example, the user can perform a drag touch operation similar to a gesture of turning the pages of a book.

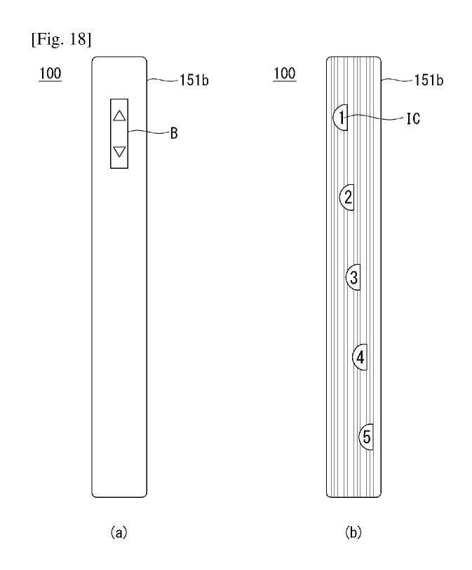

Referring to FIG. 18(a), a button B may be displayed on the second display unit 151b prior to application of touch operation of the user to the display unit. The button B may be a conventional soft key through which a control signal for the mobile terminal 100 can be input. For example, the user can control volume through the button B.

Referring to FIG. 18(b), when the user touches the first display unit 151a, the controller 180 may change display of the second display unit 151b. That is, a first state in which the button B is displayed can be changed to a second state in which manipulation with respect to the e-book displayed on the first display unit 151a can be applied. For example, the second display unit 151b can display indexes through which specific chapters can be accessed.

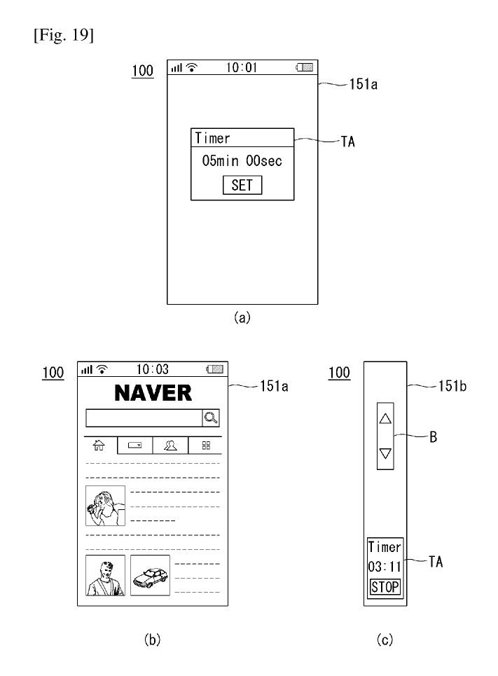

FIGS. 19 to 21 illustrate operations of the mobile terminal shown in FIG. 6 according to another embodiment of the present invention.

As shown in FIGS. 19 to 21, the controller 180 of the mobile terminal 100 according to the present embodiment may change application display positions on the basis of priority of applications.

Referring to FIG. 19(a), the user may use a specific application. For example, the user can set a timer application TA. To set a timer, the timer application needs to be displayed on the display unit 151 and the user needs to set the timer. Accordingly, the timer application may be displayed on the first display unit 151a. That is, the timer application TA can be considered to currently have high priority.

Referring to FIG. 19(b), the user may use an application other than the timer application TA. For example, the user can use an application for web surfing after setting a timer using the timer application TA. That is, the web-surfing application can be considered to currently have higher priority than the timer application TA.

Referring to FIG. 19(c), the controller 180 may display the timer application TA having lower priority on the second display unit 151b. That is, the display position of the timer application TA can be moved from the first display unit 151a to the second display unit 151b such that display of the web-surfing application currently used by the user is not disturbed.

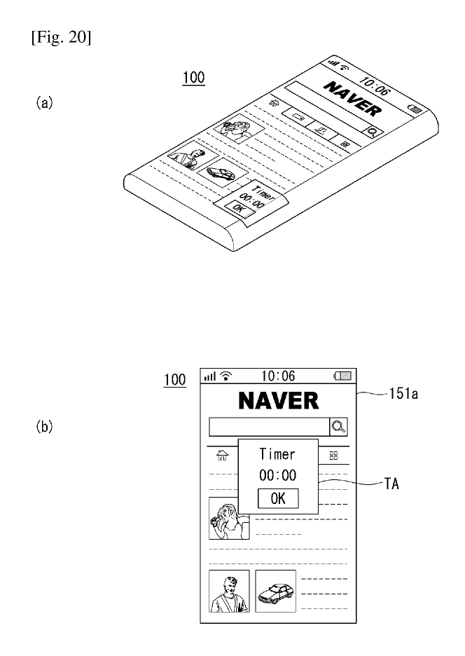

Referring to FIG. 20(a), the controller 180 may display the application, which has been displayed on the second display unit 151b, on the first display unit 151a according to priority change. For example, upon expiration of set time of the timer application TA displayed on the second display unit 151a, the controller 180 needs to inform the user of generation of the corresponding event. That is, priority of the timer application TA increases.

The controller 180 may display an application with increased priority on the first display unit 151b. For example, display of the application on the second display unit 151b can be moved to the first display unit 151a while animation effects are applied to the application. When the display position of the specific application is moved to the first display unit 151a, the user can easily visually recognize the corresponding application.

Referring to FIG. 20(b), the controller may change the display position of the specific application from the second display unit 151b to the first display unit 151a and display the specific application on the first display unit 151 such that the user can easily recognize the application.

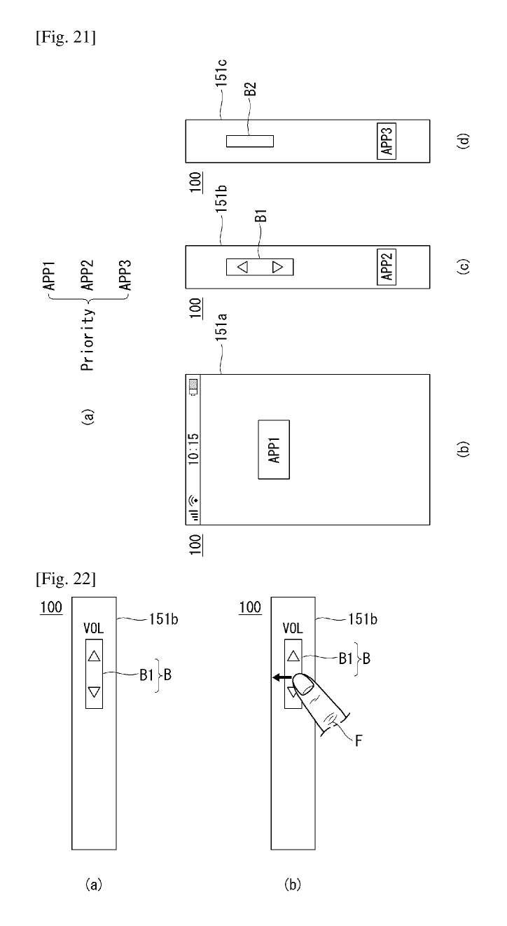

Referring to FIG. 21(a), priority may be present among applications 1, 2 and 3 (APP1, APP2 and APP3).

Referring to FIGS. 21(b), (c) and (d), the controller 180 may change application display positions according to application priority. For example, the controller 180 can display application 1 APP1 with highest priority on the first display unit 151a, display application 2 APP2 with next priority on the second display unit 151b and display application 3 APP3 with next priority on the third display unit 151c.

The controller 180 may change the application display positions upon change of priority. For example, when the priority of application 1 APP1 displayed on the first display unit 151a becomes lower than the priority of application 2 APP2 displayed on the second display unit 151b, the display positions of application 1 APP1 and application 2 APP2 can be changed.

FIGS. 22 to 24 illustrate operations of the mobile terminal shown in FIG. 6 according to another embodiment of the present invention.

As shown in FIGS. 22 to 24, the controller 180 of the mobile terminal 100 according to the present embodiment may display a button B which can be changed on the second display unit 151b. Accordingly, the display area can be effectively used.

Referring to FIG. 22(a), the second display unit 151b may display the button B which may be a volume button B1 for volume control.

Referring to FIG. 22(b), the user may touch the second display unit 151b. Here, the touch operation may differ from a touch operation of selecting the function of the button B. For example, the user can perform a touch operation of dragging a region where the button B is displayed in the horizontal direction.

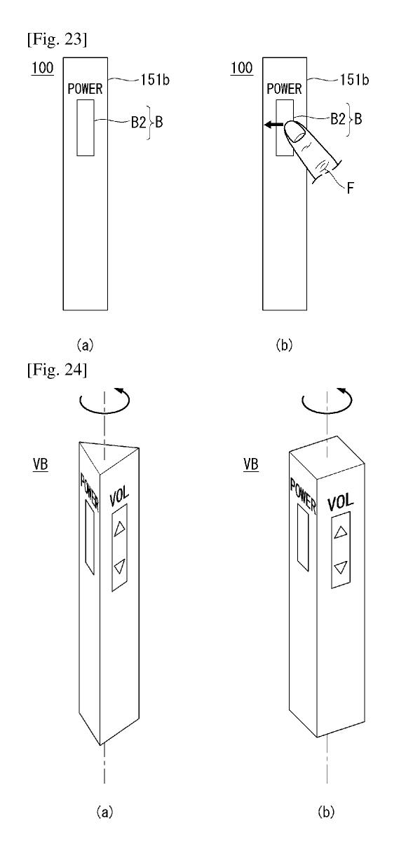

Referring to FIG. 23(a), upon application of the drag touch operation, the controller 180 may change the type of the displayed button B. For example, the volume button B1 can be changed to a power button B2.

Referring to FIG. 23(b), the user may perform a touch operation different from a touch operation of selecting the function of the power button B2. The controller 180 may change the power button B2 to a button having a property different from that of the power button B2 in response to the touch operation of the user. Since the button B can be changed to a button of a different type according to specific touch operation of the user, the limited display area can be effectively used.

Referring to FIG. 24(a), the button B may be considered to be provided to a virtual rotating body VB. For example, buttons of different types can be respectively provided to faces of the virtual rotating body VB in the form of a triangular prism. The virtual rotating body VB may be displayed on the second display unit 151b while rotating in a specific direction according to touch operation of the user.

Referring to FIG. 24(b), the virtual rotating body VB may have various forms. For example, the virtual rotating body VB can have the form of a square pillar or a form having a larger number of faces. The number of types of buttons B that can be displayed on the second display unit 151b may increase as the number of faces of the virtual rotating body VB increases. Types of buttons B displayed on the virtual rotating body VB may depend on types of applications being executed in the mobile terminal 100.

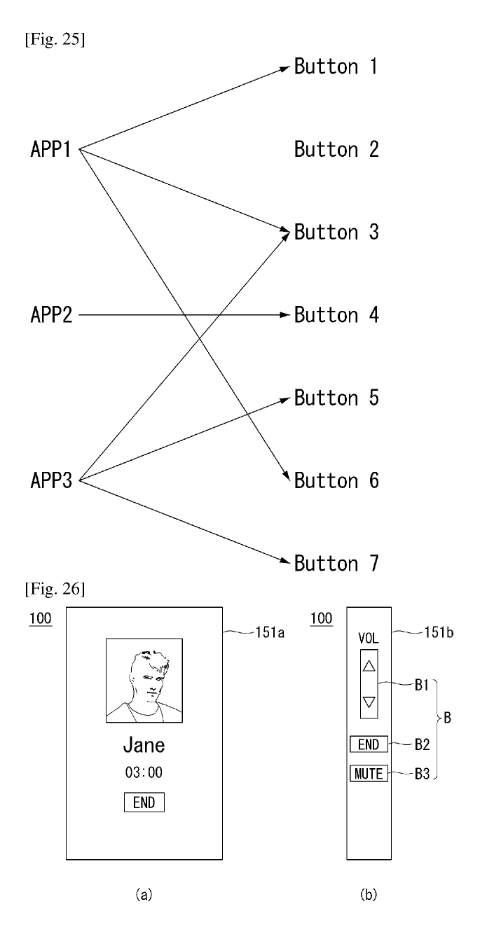

FIGS. 25 to 29 illustrate operations of the mobile terminal shown in FIG. 6 according to another embodiment to the present invention.

As shown in FIGS. 25 to 29, the controller 180 of the mobile terminal 100 according to the present embodiment may relate a specific application to a specific button. That is, the controller 180 can control a button having the specific function to be displayed upon execution of the specific application.

Referring to FIG. 25, applications 1, 2 and 3 APP1, APP2 and APP3 may be respectively associated with specific buttons. For example, the first application APP1 can be associated with buttons 1, 3 and 6 and the third application APP3 can be associated with buttons 3, 5 and 6. That is, applications can be associated with different buttons as necessary.

The controller 180 may display a button corresponding to a specific application on the basis of association information upon execution of the specific application. The button may be displayed on the second display unit 151b.

Referring to FIG. 26(a), the mobile terminal 100 may execute a call function. That is, a call application can be executed. Upon execution of the call application, the first display unit 151a may display information related to the corresponding calling operation.

Referring to FIG. 26(b), the controller 180 may display a button B related to the call application on the second display unit 151b. For example, a volume button B1, a call end button B2 and a mute button B3, which are related to the call function, can be displayed on the second display unit 151b. Some of the displayed buttons B may disappear from the second display unit 151b upon end of the call function.

Since the second display unit 151b is displayed on the side of the mobile terminal 100, the user can readily select the button B while holding the mobile terminal 100 for a call. In addition, the second display unit 151b can be effectively used since the buttons B related to the call function are selectively displayed thereon.

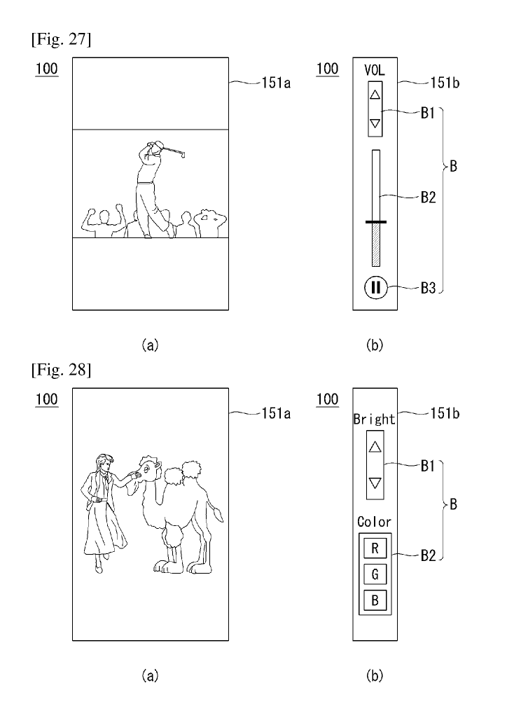

Referring to FIG. 27(a), the mobile terminal 100 may execute a video play function. The played video may be displayed on the first display unit 151a.

Referring to FIG. 27(b), upon execution of the video play function, buttons related to the played video may be displayed on the second display unit 151b. For example, a volume button B1, a playback position button B2 and a start/stop button B3 can be displayed on the second display unit 151b. The buttons B related to video playback may be displayed along with video playback and disappear upon end of playback.

Referring to FIG. 28(a), the mobile terminal 100 may execute a picture display function. A displayed picture may be displayed on the first display unit 151a.

Referring to FIG. 28(b), upon execution of the picture display function, buttons B related to the displayed picture may be displayed on the second display unit 151b. For example, a brightness button B1 for brightness control and a color button B2 for color control can be displayed on the second display unit 151b.

Referring to FIG. 28, a specific function capable of controlling an executed function may be executed through the second display unit 151b.

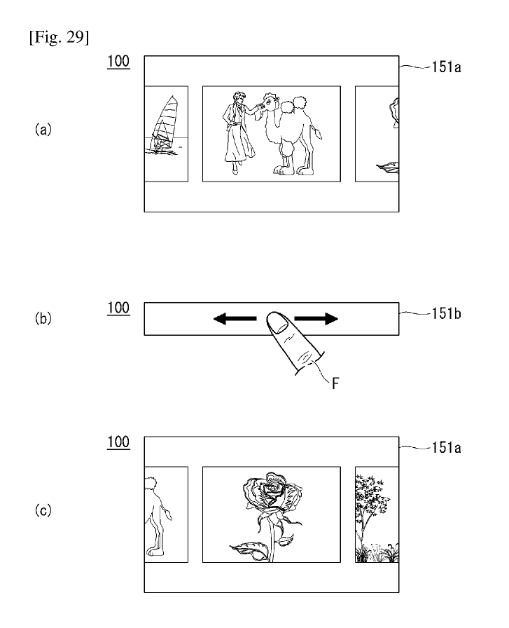

Referring to FIG. 29(a), images may be displayed on the first display unit 151a of the mobile terminal 100. For example, an image gallery application can be executed.

Referring to FIG. 29(b), the user may touch the second display unit 151b with a finger F. The touch operation applied to the second display unit 151b may be associated with a function of changing the position of an image displayed on the first display unit 151a.

Referring to FIG. 29(c), the controller 180 may change images displayed on the first display unit 151a in response to the user's touch operation applied to the second display unit 151b.

The embodiments of the present invention described above are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in embodiments of the present invention may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present invention or included as a new claim by subsequent amendment after the application is filed.

The embodiments of the present invention may be achieved by various means, for example, hardware, firmware, software, or a combination thereof. In a hardware configuration, the methods according to exemplary embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, an embodiment of the present invention may be implemented in the form of a module, a procedure, a function, etc. Software code may be stored in a memory unit and executed by a processor. The memory unit is located at the interior or exterior of the processor and may transmit and receive data to and from the processor via various known means.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

### INDUSTRIAL APPLICABILITY

While the method for setting a search space for a downlink control channel in a wireless communication system and the apparatus therefor have been described in the context of a 3GPP LTE system, the present invention is also applicable to many other wireless communication systems.

1. A mobile terminal, comprising:
a case having a plurality of faces;
a sensing unit provided inside the case;
a display unit seamlessly provided to at least two of the plurality of faces; and
a controller configured to display a first display unit and a second display unit of the display unit such that the first display unit and the second display unit respectively correspond to a first face and a second face of an entity and to change an image displayed on at least one of the first and second display units to correspond to a position change of the case upon sensing of the position change of the case through the sensing unit, the first and second display units having different directions.

2. The mobile terminal of claim 1, wherein the controller is configured to change a first state of the second display unit to a second state and to display the second display unit upon sensing of the position change of the case.

3. The mobile terminal of claim 2, wherein the controller is configured to display the front side of a book corresponding to the entity on the first display unit and to display a side of the book on the second display unit,
wherein the second state is a state in which indexes including chapter indexes and/or points designated by a user are displayed on the second display unit.

4. The mobile terminal of claim 3, wherein, upon selection of at least one of the indexes displayed on the second display unit, the controller is configured to display an image corresponding to the index on the first display unit.

5. The mobile terminal of claim 1, wherein the controller is configured to display at least one of a plurality of applications being executed on the first display unit and to display at least one other of the applications on the second display unit according to priority of the applications.

6. The mobile terminal of claim 5, wherein the controller is configured to change the application displayed on one of the first and second display units to the application displayed on the other display unit when the priority is changed.

7. The mobile terminal of claim 1, wherein the controller is configured to change at least one input button displayed on the second display unit to at least another input button and to display the changed input button upon acquisition of user touch input applied to the second display unit.

8. The mobile terminal of claim 1, wherein the controller is configured to change at least one of buttons displayed on the second display unit and to display the changed button according to an application being executed.

9. The mobile terminal of claim 1, wherein the first display unit is provided to the front side of the case and the second display unit is provided to both sides of the case on the basis of the first display unit.

10. The mobile terminal of claim 1, wherein at least one button through which user manipulation is applied to the mobile terminal is provided to the backside of the case.

11. A method for controlling a mobile terminal, comprising:
providing a first display unit and a second display unit having different directions such that the first display unit and the second display unit respectively correspond to a first face and a second face of an entity;
sensing position change of a case; and
changing an image displayed on at least one of the first and second display units to correspond to the position change of the case.

12. The method of claim 11, wherein the changing of the image comprises changing a first state of the second display unit to a second state and displaying the second display unit upon sensing of the position change of the case.

13. The method of claim 11, further comprising displaying at least one of a plurality of applications being executed on the first display unit and displaying at least one other of the applications on the second display unit according to priority of the applications.
